(19) United States
(12) Patent Application Publication
(10) Pub. No.: US 2024/0291668 A1
(43) Pub. Date: Aug. 29, 2024

(54) INTERNET-OF-THINGS DEVICE IDENTITY AUTHENTICATION METHOD, APPARATUS AND SYSTEM, AND STORAGE MEDIUM

(71) Applicant: GUANGDONG UNIVERSITY OF PETROCHEMICAL TECHNOLOGY, Maoming (CN)

(72) Inventors: Guanhua Zhu, Maoming (CN); Qinghua Zhang, Maoming (CN); Guoxi Sun, Maoming (CN); Chenglin Wen, Maoming (CN); Shaolin Hu, Maoming (CN); Yebin Cai, Maoming (CN); Xiaoyuan Jing, Maoming (CN); Quansi Huang, Maoming (CN); Zirun Gan, Maoming (CN)

(21) Appl. No.: 18/660,283

(22) Filed: May 10, 2024

Related U.S. Application Data
(63) Continuation-in-part of application No. PCT/CN2022/127810, filed on Oct. 27, 2022.

(30) Foreign Application Priority Data
Nov. 11, 2021 (CN) 202111331483.X

(51) Int. Cl. H04L 9/32; G16Y 30/10; H04L 9/08

(52) U.S. Cl. CPC H04L 9/3242; G16Y 30/10; H04L 9/0866

(57) ABSTRACT

Disclosed are an Internet-of-Things device identity authentication method, apparatus and system, and a storage medium. The method includes: sending an identity authentication request so that a server device generates a first authentication code; receiving the first authentication code, generating a second authentication code, and determining that an identity of the server device is valid when the first and second authentication code are consistent; encrypting the first authentication code to generate a third authentication code; and sending the third authentication code and a preconfigured encrypted data packet to the server device, so that the server device decrypts the third authentication code to generate a fourth authentication code, decrypts the encrypted data packet to obtain device authentication information when the first and fourth authentication code are consistent, and determines that an identity of a client device is valid when the device authentication information is consistent with device-specific information of the client device.

### CROSS REFERENCE TO RELATED APPLICATIONS

The present application is a Continuation-In-Part Application of PCT Application No. PCT/CN2022/127810 filed on Oct. 27, 2022, which claims the benefit of Chinese Patent Application No. 202111331483.X filed on Nov. 11, 2021. All the above are hereby incorporated by reference in their entirety.

### TECHNICAL FIELD

The present disclosure relates to the technical field of the Internet of Things, and particularly relates to an Internet-of-Things device identity authentication method, apparatus, and system, and a computer-readable storage medium.

### BACKGROUND

The Internet of Things refers to an intelligent service system that connects things, people, systems, and information resources according to agreed protocols through Internet-of-Things devices with sensing and communication capabilities, in order to process and respond to information of physical and virtual worlds. Nowadays, the deep integration of the Internet of Things with various industries breeds emerging application scenarios such as smart homes, smart cities, etc. With the rapid development of the Internet of Things, a large number of Internet-of-Things devices are hosted on mobile-Internet servers for management, and the Internet-of-Things devices are facing increasingly high security and privacy challenges. The device identity authentication is a first step in the security of the entire Internet of Things. An identity authentication mechanism refers to a security mechanism that identifies and authenticates identities of devices accessing an Internet-of-Things system before data interaction.

Currently, there are mainly 4 commonly-used identity authentication patterns in the Internet-of-Things system, i.e., smart card authentication, user name/password authentication, dynamic password authentication, and digital certificate-based identity authentication, respectively. The smart card authentication is smart card-based identity authentication, which belongs to a mechanism of performing identity authentication through physical devices, with static authentication data. The user name/password authentication is a simplest and commonest identity authentication method, which is an authentication means that is based on “what you know”, with the password being static data. Regarding the dynamic password authentication, a basic authentication principle of a dynamic password is that both authentication parties use the same shared key to perform password algorithm computation on the time, and then compare computed values to determine whether they are consistent, thereby implementing the authentication. The digital certificate-based identity authentication is a digital certificate authentication pattern that is based on a PKI (Public Key Infrastructure) architecture.

Due to limited computing capabilities and storage resources of the Internet-of-Things devices, excessively complex algorithms cannot be operated in the Internet of Things. The use of complex algorithms may lead to the accelerated energy consumption and storage resource consumption of the Internet-of-Things devices, or to excessively long decryption time. If no or simple identity authentication encryption algorithms are configured, the Internet-of-Things devices may be easily cracked by attackers who thus obtain user privacy data. The openness of the mobile Internet brings many security threats to the hosted Internet-of-Things devices, for example, the attackers use some devices to perform brute force attack and exhaustive attack on the servers. In addition, the Internet-of-Things devices have limited computing capabilities, which makes the Internet-of-Things devices unable to load complex security measures. Many Internet-of-Things devices are used in user sensitive scenarios, with data comprising a mass of user privacies, a leakage of which may lead to serious consequences.

To sum up, in identity authentication processes, some of the common identity authentication patterns use static information or the addition of a smart card, and the others have cumbersome authentication processes which result in excessive resource consumption, all of which cannot satisfy security requirements of the Internet of Things system.

### SUMMARY

Embodiments of the present disclosure provide an Internet-of-Things device identity authentication method, apparatus, and system, and a computer-readable storage medium, in order to achieve bidirectional authentication between both interaction parties, thereby reducing resource consumption of Internet-of-Things devices and improving the security of an Internet-of-Things system.

In first aspects, to solve the above technical problems, the embodiments of the present disclosure provide an Internet-of-Things device identity authentication method, which is executed by a client device and comprises:
sending identity authentication request information to a server device, so that the server device receives the identity authentication request information, generates a first authentication code according to a preset first encryption algorithm, and sends the first authentication code to the client device;
receiving the first authentication code, generating a second authentication code according to the first encryption algorithm, and comparing the second authentication code with the first authentication code;
determining that an identity of the server device is valid when it is determined that the second authentication code is consistent with the first authentication code;
encrypting the first authentication code according to a preset second encryption algorithm to generate a third authentication code after it is determined that the identity of the server device is valid; and
sending the third authentication code and a preconfigured encrypted data packet to the server device, so that the server device runs the second encryption algorithm reversely to decrypt the received third authentication code to generate a fourth authentication code, compares the fourth authentication code with the first authentication code, decrypts the received encrypted data packet to obtain device authentication information when it is determined that the fourth authentication code is consistent with the first authentication code, and determines that an identity of the client device is valid when it is determined that the device authentication information is consistent with device-specific information of the client device.

In an embodiment, the method further comprises:
receiving an image authentication code, and running a preset image generation algorithm reversely to decrypt the image authentication code to obtain the first authentication code, wherein the image authentication code is generated by the server device according to the image generation algorithm and the first authentication code and sent to the client device.

In an embodiment, the running the preset image generation algorithm reversely to decrypt the image authentication code to obtain the first authentication code comprises:
reading information of the image authentication code, and deleting preset interference information, so as to obtain a decimal numerical value;
converting the decimal numerical value into a binary numerical value, and performing a reverse bitwise cyclic operation on the binary numerical value, so as to obtain an initial binary numerical value; and
performing a decimal conversion on the initial binary numerical value to obtain the first authentication code.

In an embodiment, the generating the second authentication code according to the first encryption algorithm comprises:
generating a time period number according to a preset dynamic time interval and obtained current time of the client device;
performing computation on the current time of the client device, the time period number, and the dynamic time interval to obtain an initial second authentication code; and
processing the initial second authentication code according to a preset number of authentication code bits, so as to obtain the second authentication code.

In an embodiment, the method further comprises:
updating the time period number to a time period number of a previous time when determining for a first time that the second authentication code is inconsistent with the first authentication code, and returning to the performing the computation on the current time of the client device, the time period number, and the dynamic time interval to obtain the initial second authentication code, thereby obtaining an updated second authentication code; and
comparing the updated second authentication code with the first authentication code.

In an embodiment, the encrypting the first authentication code according to the preset second encryption algorithm to generate the third authentication code comprises:
adding a preset encryption number to the first authentication code to generate the third authentication code.

In second aspects, the present disclosure provides an Internet-of-Things device identity authentication apparatus, which is disposed in a client device and comprises:
a request sending module configured to send identity authentication request information to a server device, so that the server device receives the identity authentication request information, generates a first authentication code according to a preset first encryption algorithm, and sends the first authentication code to the client device;
a first comparison module configured to receive the first authentication code, generate a second authentication code according to the first encryption algorithm, and compare the second authentication code with the first authentication code;
a first determination module configured to determine that an identity of the server device is valid when it is determined that the second authentication code is consistent with the first authentication code;
a first encryption module configured to encrypt the first authentication code according to a preset second encryption algorithm to generate a third authentication code after it is determined that the identity of the server device is valid; and
a first sending module configured to send the third authentication code and a preconfigured encrypted data packet to the server device, so that the server device runs the second encryption algorithm reversely to decrypt the received third authentication code to generate a fourth authentication code, compares the fourth authentication code with the first authentication code, decrypts the received encrypted data packet to obtain device authentication information when it is determined that the fourth authentication code is consistent with the first authentication code, and determines that an identity of the client device is valid when it is determined that the device authentication information is consistent with device-specific information of the client device.

In third aspects, the present disclosure further provides an Internet-of-Things device identity authentication method, which is executed by a server device and comprises:
receiving identity authentication request information, and generating a first authentication code according to a preset first encryption algorithm, wherein the identity authentication request information is generated and sent to the server device by a client device;
sending the first authentication code to the client device, so that the client device generates a second authentication code according to the first encryption algorithm, compares the second authentication code with the received first authentication code, determines that an identity of the server device is valid when it is determined that the second authentication code is consistent with the first authentication code, encrypts the first authentication code according to a preset second encryption algorithm to generate a third authentication code after it is determined that the identity of the server device is valid, and sends the third authentication code and a preconfigured encrypted data packet to the server device;
receiving the encrypted data packet and the third authentication code;
running the second encryption algorithm reversely to decrypt the third authentication code to generate a fourth authentication code, and comparing the fourth authentication code with the first authentication code;
decrypting the encrypted data packet to obtain device authentication information when it is determined that the fourth authentication code is consistent with the first authentication code; and
determining that an identity of the client device is valid when it is determined that the device authentication information is consistent with device-specific information of the client device.

In an embodiment, the generating the first authentication code according to the preset first encryption algorithm comprises:
generating a time period number according to a preset dynamic time interval and the obtained current time of the server device;
performing computation on the current time of the server device, the time period number, and the dynamic time interval, so as to obtain an initial first authentication code; and
processing the initial first authentication code according to a preset number of authentication code bits, so as to obtain the first authentication code.

In an embodiment, the method further comprises:
generating an image authentication code according to a preset image generation algorithm and the first authentication code, and sending the image authentication code to the client device, so that the client device runs the image generation algorithm reversely to decrypt the received image authentication code to obtain the first authentication code.

In an embodiment, the generating the image authentication code according to the preset image generation algorithm and the first authentication code comprises:
converting the first authentication code into an initial binary numerical value;
performing a bitwise cyclic operation on the initial binary numerical value to obtain a binary numerical value;
writing the binary numerical value to image data preconfigured by the server device, so as to generate an initial image authentication code; and
adding preset interference information to the initial image authentication code to generate the image authentication code.

In an embodiment, the running the second encryption algorithm reversely to decrypt the third authentication code to generate the fourth authentication code comprises:
deleting a preset encryption number from the third authentication code to generate the fourth authentication code.

In fourth aspects, the present disclosure further provides an Internet-of-Things device identity authentication apparatus, which is disposed in a server device and comprises:
a second encryption module configured to receive identity authentication request information, and generate a first authentication code according to a preset first encryption algorithm, wherein the identity authentication request information is generated and sent to the server device by a client device;
a second sending module configured to send the first authentication code to the client device, so that the client device generates a second authentication code according to the first encryption algorithm, compares the second authentication code with the received first authentication code, determines that an identity of the server device is valid when it is determined that the second authentication code is consistent with the first authentication code, encrypts the first authentication code according to a preset second encryption algorithm to generate a third authentication code after it is determined that the identity of the server device is valid, and sends the third authentication code and a preconfigured encrypted data packet to the server device;
a first receiving module configured to receive the encrypted data packet and the third authentication code;
a second comparison module configured to run the second encryption algorithm reversely to decrypt the third authentication code to generate a fourth authentication code, and compare the fourth authentication code with the first authentication code;
a first decryption module configured to decrypt the encrypted data packet to obtain device authentication information when it is determined that the fourth authentication code is consistent with the first authentication code; and
a second determination module configured to determine that an identity of the client device is valid when it is determined that the device authentication information is consistent with device-specific information of the client device.

In fifth aspects, the present disclosure further provides an Internet-of-Things device identity authentication system comprising a client device and a server device that are communicatively connected with each other. The client device is configured to execute the Internet-of-Things device identity authentication method as described in any one of the first aspects, and the server device is configured to execute the Internet-of-Things device identity authentication method as described in any one of the third aspects.

In sixth aspects, the present disclosure further provides a computer-readable storage medium comprising a stored computer program, wherein the computer program, when being run, controls a device where the computer-readable storage medium is located to execute the Internet-of-Things device identity authentication method as described in any one of the first aspects or the Internet-of-Things device identity authentication method as described in any one of the third aspects.

Compared with the existing technology, the embodiments of the present disclosure have the following beneficial effects:

In the embodiments of the present disclosure, the client device performs identity authentication for the server device, and then sends the processed third authentication code and the encrypted data packet to the server device after determining that the identity of the server device is valid. The server device then performs identity authentication for the client device, thereby achieving bidirectional authentication between both interaction parties. Meanwhile, the embodiments of the present disclosure do not require multiple times of cyclic decryptions and do not involve multiple recursive iterations or public or private keys, etc., have the advantages of few resources occupied and a fast authentication speed, and are applicable to devices with low computer technology capabilities and storage resources.

### BRIEF DESCRIPTION OF THE DRAWINGS

FIG. 1 is a flow diagram of a preferable embodiment of an Internet-of-Things device identity authentication method provided by the present disclosure;

FIG. 2 is a schematic structural diagram of a preferable embodiment of an Internet-of-Things device identity authentication method provided by the present disclosure;

FIG. 3 is a flow diagram of another preferable embodiment of an Internet-of-Things device identity authentication method provided by the present disclosure; and

FIG. 4 is a schematic structural diagram of another preferable embodiment of an Internet-of-Things device identity authentication method provided by the present disclosure.

### DETAILED DESCRIPTION

The technical solution in embodiments of the present disclosure will be clearly and completely described below in conjunction with the drawings in the embodiments of the present disclosure. Apparently, the described embodiments are only part, but not all, of the embodiments of the present disclosure. Based on the embodiments in the present disclosure, all other embodiments obtained by those of ordinary skill in the art without the exercise of inventive effort fall within the scope of protection of the present disclosure.

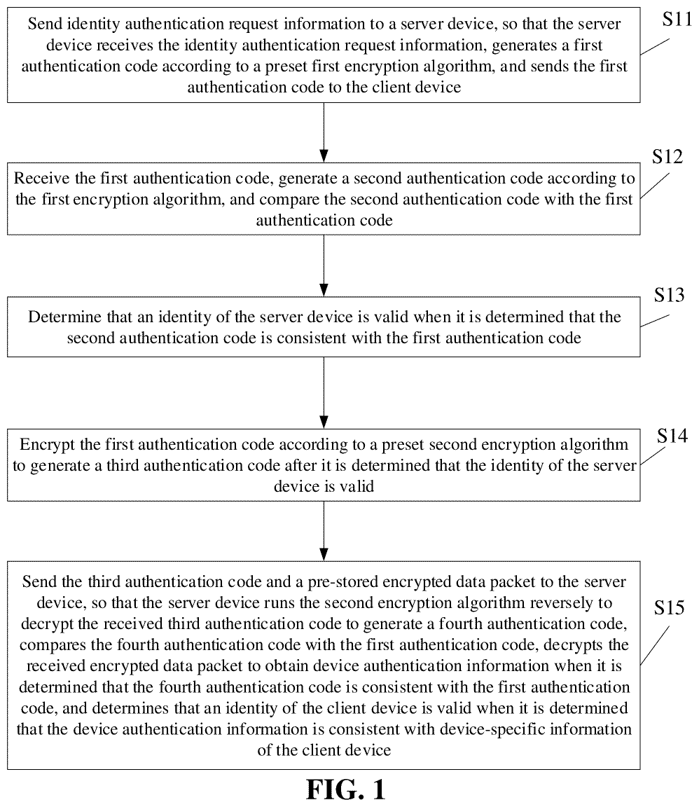

Referring to FIG. 1, first embodiments of the present disclosure provide an Internet-of-Things device identity authentication method, which comprises following steps S11-S15:
S11, sending identity authentication request information to a server device, so that the server device receives the identity authentication request information, generates a first authentication code according to a preset first encryption algorithm, and sends the first authentication code to a client device;
S12, receiving the first authentication code, generating a second authentication code according to the first encryption algorithm, and comparing the second authentication code with the first authentication code;
S13, determining that an identity of the server device is valid when determining that the second authentication code is consistent with the first authentication code;
S14, encrypting the first authentication code according to a preset second encryption algorithm to generate a third authentication code after determining that the identity of the server device is valid; and
S15, sending the third authentication code and a preconfigured encrypted data packet to the server device, so that the server device runs the second encryption algorithm in reverse to decrypt the received third authentication code to generate a fourth authentication code, compares the fourth authentication code with the first authentication code, decrypts the received encrypted data packet to obtain device authentication information when determining that the fourth authentication code is consistent with the first authentication code, and determines that an identity of the client device is valid when determining that the device authentication information is consistent with device-specific information of the client device.

It is to be noted that registration of the client device in Internet-of-Things devices is required to be performed before the authentication starts. A registration process involves three aspects: a system administrator, the server device, and a user. First, the user applies to the server device for registration and submits a mobile phone number and password information of the user. The system administrator authenticates whether the user is a user of the system, and if so, accepts the registration application of the user and configures some operating permissions for the user, e.g., permissions to add and delete a device, modify device information, and modify a device account password, etc.

Further, after the user registration succeeds, the user logs in the server device and initiates a client device registration application after the login succeeds. The server device returns a device-specific information submission interface according to received client device registration application information. The user enters the device-specific information of the client device on the interface and sends the device-specific information to the server device. The device-specific information includes information such as a unique IP address, a machine code, an account, and a password, etc., of the client device.

The server device generates a specific data packet corresponding to the client device according to the received device-specific information, encrypts the specific data packet using a preset specific encryption algorithm to generate the encrypted data packet, and sends the encrypted data packet to the client device. The client device preconfigures and stores the encrypted data packet to a designated location. The specific encryption algorithm is agreed and configured by both parties in advance, for example, a Data Encryption Algorithm (DEA) may be used, which is not limited in the present disclosure.

Further, the server device may also generate a device-dedicated program based on the device-specific information and send the program to the client device. Compared with digital certificate identity authentication in the existing technology, in the present disclosure, when the client device applies for the registration, the device-dedicated program is generated based on the specific information of the client device, which can resist a forgery attack, a forgery identity attack, a man-in-the-middle attack, etc., thereby improving the security of an Internet-of-Things device identity authentication system.

In this embodiment, the user may also install the device-dedicated program sent by the server device into the client device according to the encrypted data packet. After the program installation succeeds, the client device starts running the program and stores account information and password information in the encrypted data packet. After the program installation succeeds and the account and password information storage succeeds, the client device may also send program installation success and account and password information storage success information to the server device. After receiving the information, the server device determines that the device registration succeeds. After the program installation succeeds and the account and password information storage succeeds, the client device executes step S11 to send the identity authentication request information to the server device.

In step S11, the client device sends the identity authentication request information to the server device. The server device receives the identity authentication request information, generates the first authentication code according to the preset first encryption algorithm, and sends the first authentication code to the client device.

It is to be noted that input data of the first encryption algorithm is dynamic and varies over time. For example, a time synchronization authentication-based dedicated encryption method is used to generate the first authentication code that is based on current time of the server device.

In step S12, the client device receives the first authentication code, generates the second authentication code according to the first encryption algorithm, and compares the second authentication code with the first authentication code. The input data of the first encryption algorithm is dynamic and varies over time. For example, the time synchronization authentication-based dedicated encryption method is used to generate the second authentication code that is based on current time of the client device.

In steps S13 and S14, the client device determines that the identity of the server device is valid when determining that the second authentication code is consistent with the first authentication code. After determining that the identity of the server device is valid, the first authentication code is encrypted according to the preset second encryption algorithm to generate the third authentication code. In an implementation, a preset encryption number is added to the first authentication code to generate the third authentication code. In an implementation, the preset encryption number may be a large number.

In step S15, the third authentication code and the preconfigured encrypted data packet are sent to the server device. For example, the third authentication code may be combined with the encrypted data packet to generate a string which is sent to the server device for comparative authentication. Finally, all authentication code information buffered on the client device is deleted to prevent them from misappropriation by others.

Further, the server device runs the second encryption algorithm reversely to decrypt the received third authentication code to generate the fourth authentication code, and compares the fourth authentication code with the first authentication code. When determining that the fourth authentication code is consistent with the first authentication code, the preset specific encryption algorithm is run reversely to decrypt the received encrypted data packet to obtain the device authentication information. The device authentication information keeps consistent with the device-specific information, may be set by both interaction parties in advance, and includes information such as the unique IP address, the machine code, the account, and the password, etc., of the client device. The identity of the client device is determined to be valid when that the device authentication information is determined to be consistent with the device-specific information.

In an implementation, the server device receives the string sent by the client device, and deletes the encryption number from the third authentication code to generate the fourth authentication code. The server device compares the decrypted fourth authentication code with the first authentication code. When the fourth authentication code is determined to be consistent with the first authentication code, it indicates that the comparison succeeds. Then the encrypted data packet at the rear of the string is decrypted using the specific encryption algorithm, so as to read the device authentication information that includes the account and the password of the device. It is to be noted that, in the case where it is determined that the fourth authentication code is inconsistent with the first authentication code, the server device does decrypt the encrypted data packet and does not obtain the account and password information.

Further, when determining that the device authentication information is consistent with the device-specific information, the identity of the client device is determined to be valid, and authentication passing information is sent to the client device. When the device authentication information is determined to be inconsistent with the device-specific information, it indicates that account and password authentication fails, and password error information is sent to the client device.

In order to facilitate an understanding of the present disclosure, some preferable embodiments of the present disclosure will be further described below.

In an implementation, generating, by the server device, the first authentication code according to the preset first encryption algorithm comprises following steps S21-S23:

S21, generating a time period number according to a preset dynamic time interval and the obtained current time of the server device;

S22, performing computation on the current time of the server device, the time period number, and the dynamic time interval, so as to obtain an initial first authentication code; and

S23, processing the initial first authentication code according to a preset number of authentication code bits, so as to obtain the first authentication code.

In step S21, the time period number needs to be generated according to the preset dynamic time interval and the obtained current time of the server device. In an implementation, the server device first obtains the current time, i.e., year, month, day, hour, minute, and second, and then performs an operation on the minute and the second in the current time with a formula as follows:

$$\frac{( A \cdot 60 ) + B}{T} = J \qquad ( 1 )$$

where A represents the minute in the current time obtained by the server device, B represents the second in the current time obtained by the server device, T represents the dynamic time interval, and J represents the time period number “XX”, which is only an integer with no remainder. The dynamic time interval T is a dynamic number, with a range of the dynamic time interval T being set by an administrator during an update process. The server device randomly selects one number from this range every day as the dynamic time interval T for that day. In this embodiment, the time period number obtained after the operation of the above formula (1) is: J=XX, J being a two-bit numerical value. In other embodiments, front complementation processing is performed if the numerical value of J is less than two bits. For example, if J=1 is obtained through the above formula (1), the complement processing is performed using 0 for complementation, thereby obtaining the final J of 01.

In step S22, the computation needs to be performed on the current time of the server device, the time period number, and the dynamic time interval, so as to obtain the initial first authentication code. In an implementation, the server device performs an operation on a numerical value of the year, month, day, and hour in the obtained current time with the following formula:

$$\frac{C}{D} = F … G \qquad ( 2 )$$

where C represents the year, month, day, and hour, i.e., “YYYYMMDDHH”, in the obtained current time; D represents a combination of the time period number and the dynamic time interval, i.e., JT, for example, if J=01 and T=90, D=0190; F represents a quotient of the above operation of formula (2); and G represents a remainder of the above operation of formula (2). Further, F, G, and J are combined to obtain the initial first authentication code, e.g., “519560212138”.

In step S23, the initial first authentication code is processed according to the preset number of authentication code bits, so as to obtain the first authentication code. It is to be noted that in an embodiment, the initial first authentication code obtained by step S22 is “519560212138”. However, in a particular implementation, resultant final authentication code lengths are inconsistent if initial first authentication codes are obtained through direct combination, with several bits longer in some cases and several bits shorter in other cases. In order to unify a length of the string, after three numerical values of F, G, and J are obtained, several bits of F and G are selected according to the preset number of authentication code bits, followed by the FGJ combination. The number of authentication code bits may be configured according to a user need, which is not limited in the present disclosure.

For example, assuming that the current time is 21:58:20 on 5 Sep. 2021 and T=90, J=38 is obtained after the operation of formula (1), in which case C=2021090521 and D=3890. In this embodiment, F=519560 and G=2121 are obtained through the operation of formula (2). Taking an 8-bit authentication code as an example, first three bits of each of F and G are selected in this case, with F=519 and G=212 after the bit selection. Finally, the FGJ combination is performed to generate the current time-based first authentication code of 51921238. In other embodiments, front complementation processing is performed if a numerical value of G is less than three bits. For example, if G=1 is obtained through the above formula (2), the complement processing is performed using 0 for complementation, thereby obtaining the final G of 001.

In this embodiment, the first encryption algorithm is a generation method based on time synchronization authentication encoding, and generated authentication information is dynamic information rather than static information. Compared with smart card and user name/password identity authentication methods, this method may effectively prevent snooping, a dictionary attack, an exhaustive attempt, network data stream eavesdropping, a replay attack, etc. Meanwhile, by setting the dynamic time interval T that can be modified, a numerical value of T varies every day or at intervals. Compared with a TOTP protocol in a dynamic password in the existing technology, the dynamic time interval T of the present disclosure can be modified. A server selects one numerical value from a configured range every day as an agreed time rule for that day. Moreover, rather than a selection of multiple earlier time periods for decryption, a delay strategy requires a selection of only one earlier time period for decryption, and therefore can resist a guessing attack, save the power consumption of Internet-of-Things devices, and improve the effectiveness and security of an identity authentication process.

Correspondingly, generating, by the client device, the second authentication code according to the first encryption algorithm in step S12 comprises:
generating the time period number according to the preset dynamic time interval and the obtained current time of the client device;
performing computation on the current time of the client device, the time period number, and the dynamic time interval to obtain an initial second authentication code; and
processing the initial second authentication code according to the preset number of authentication code bits, so as to obtain the second authentication code.

It is to be noted that the above steps are different from steps S21-S23 only in that what is obtained in the above steps is the current time of the client device, while what is obtained in step S21 is the current time of the server device. Other processes are no longer repeated herein.

In a preferable implementation, the method further comprises:
the server device generates an image authentication code according to a preset image generation algorithm and the first authentication code and sends the image authentication code to the client device, so that the client device runs the image generation algorithm reversely to decrypt the received image authentication code to obtain the first authentication code.

In an implementation, the server device generating the image authentication code according to the preset image generation algorithm and the first authentication code comprises following steps S31-S34:

S31, converting the first authentication code into an initial binary numerical value;
S32, performing a bitwise cyclic operation on the initial binary numerical value to obtain a binary numerical value;
S33, writing the binary numerical value to image data preconfigured by the server device, so as to generate an initial image authentication code; and
S34, adding preset interference information to the initial image authentication code to generate the image authentication code.

In step S31, the first authentication code needs to be converted into the initial binary numerical value. Information in the first authentication code is read first, and the first authentication code is converted into the initial binary numerical value, which is represented by P bytes, with 8 bits per byte.

In step S32, the bitwise cyclic operation is performed on the initial binary numerical value to obtain the binary numerical value. For example, a two-bit cyclic left shift is performed on a first byte of the initial binary numerical value, a four-bit cyclic right shift is performed on a second byte, and so on.

In an example, the first authentication code of “51921238” is used for description. “51921238” is converted into a binary number 11000110000100000101010110, with a total of 26 bits, which is converted into 00000011000110000100000101010110 after front complementation into 4 bytes, i.e., 32 bits. Byte sorting starts from right to left. A five-bit left shift is performed on a first byte 01010110, a four-bit right shift is performed on a second byte 01000001, a two-bit right shift is performed on a third byte 00011000, and a one-bit right shift is performed on a fourth byte 00000011, with the four bytes being 11001010, 00010100, 00000110, 10000001 respectively after the shifts, so as to obtain a final binary numerical value 10000001000001100001010011001010.

In step S33, the binary numerical value is written to the image data preconfigured by the server device, so as to generate the initial image authentication code. It is to be noted that in this embodiment, several background pictures are stored or randomly generated in the server device in advance. These pictures may be black and white pictures, grayscale pictures, or color pictures, etc. Figures in the pictures may be symbols, numeral numbers, or objects, etc.

Further, the background pictures stored or randomly generated in the server device are read first, and then numerical values of K points in the background pictures are used to represent the binary numerical value. A range of the K points in the pictures is randomly extracted from a picture range by the server device every day without repetition. Finally, the binary numerical value of P bytes obtained in step S22 is written correspondingly to the background pictures to generate the initial image authentication code.

In step S34, the preset interference information is added to the initial image authentication code to generate the image authentication code. The interference information may comprise L noises.

It is to be noted that different picture types require different values of K. For example, in a black and white picture, a value of a point is either 0 or 1, so K=P*8 points are required. In an RGB color picture, a value of a point is an integer between 0 and 255, which is an 8-bit binary number if converted into a binary number, so only K=4 points are required.

In a preferable implementation, the method further comprises:
the client device receives the image authentication code, and runs the preset image generation algorithm reversely to decrypt the image authentication code to obtain the first authentication code, wherein the image authentication code is generated by the server device according to the image generation algorithm and the first authentication code and sent to the client device.

In an implementation, the running the preset image generation algorithm reversely to decrypt the image authentication code to obtain the first authentication code comprises the following steps S41-S43:
S41, reading information of the image authentication code, and deleting the preset interference information, so as to obtain a decimal numerical value;
S42, converting the decimal numerical value into a binary numerical value, and performing a reverse bitwise cyclic operation on the binary numerical value, so as to obtain the initial binary numerical value; and
S43, performing a decimal conversion on the initial binary numerical value to obtain the first authentication code.

It is to be noted that the above steps S41-S43 are processes of running the image generation algorithm reversely, and an operational rule thereof is reverse to that of steps S31-S34.

In this embodiment, locations of the K points are randomly selected after picture modification, and the binary numerical value is written in a different order. An error in a reading order may also cause a decryption error. Therefore, reading a picture decryption rule from a rule storage module of the client device requires reading some points in the image authentication code and deleting the preset interference information. When a read numerical value is a decimal numerical value, the decimal numerical value needs to be converted into a binary numerical value, left and right cyclic shift operations that are reverse to those in step S32 are performed on the binary numerical value, and then K bytes are combined correspondingly to obtain the initial binary numerical value. Finally, the initial binary numerical value is converted into a decimal numerical value to obtain the first authentication code.

In an implementation, taking an RGB color picture as an example, a point may represent an 8-bit binary numerical value, i.e., one byte, and it is assumed that 4 points are set, i.e., K=4. A location of a first point is in a 15th row and a 10th column, which is represented by K1=(15, 10). Similarly, locations of the other points are K2=(20, 10), K3=(45, 1), and K4=(2, 35). K1 is first byte information, K2 is second byte information, K3 is third byte information, and K4 is fourth byte information. A decimal numerical value of 0-255 is read from the RGB color picture, and needs to be converted into a binary numerical value. Reverse left and right cyclic shift operations are performed on the K bytes. If a five-bit left shift is performed on the first byte in step S32, original byte information may be obtained simply by a reverse shift by a corresponding number of bits, i.e., performing a five-bit right shift on the first byte, and so on for the other bytes. Finally, the K bytes are sorted and combined in a descending order, i.e., a descending order of K4, K3, K2, and K1. A number obtained after the sorting and combination is the initial binary numerical value, which is then converted into a decimal numerical value to obtain the first authentication code.

In this embodiment, the randomly generated background pictures are modified, and both interaction parties agree on a rule. The client device directly reads authentication information from the pictures. Compared with a dynamic password identity authentication method, the method of the present disclosure does not require multiple times of cyclic decryption and does not involve multiple recursive iterations or public or private keys, etc., may achieve advantages of fewer resources occupied and fast authentication speed, and is applicable to devices with low computer technology capabilities and storage resources. Moreover, since an authentication code picture is generated using a method of modifying the background pictures and writing encoding information, an attacker may mistakenly consider a number, an object, and character information in the authentication code image to be identity authentication information, and therefore cannot carry out a guessing attack.

In addition, an operation method of performing the left and right cyclic shifts after converting the first authentication code into the binary numerical value is adopted. Compared with the TOTP protocol, which requires multiple recursive iterations and public and private keys, this shift operation is more convenient and faster and does not require multiple recursive iterations or public or private keys. Both encryption and decryption speeds are faster than those of the TOTP protocol, and rules of the left and right cyclic shifts may be set. Advantages of a fast authentication speed and no consumption of excessive resources may be achieved.

In a preferable implementation, the method further comprises the following steps S51-S52:
S51, when determining for a first time that the second authentication code is inconsistent with the first authentication code, updating the time period number to a time period number of a previous time, and returning to the step of performing the computation on the current time of the client device, the time period number, and the dynamic time interval to obtain the initial second authentication code, thereby obtaining an updated second authentication code; and
S52, comparing the updated second authentication code with the first authentication code.

It is to be noted that the client device may fail in the authentication process because the current time thereof is exactly at a dynamic time interval node, i.e., between an end of a current time period and a start of a next time period. In this case, the obtained time may vary. When the client device receives the image authentication code, the time skips to a time period corresponding to a next time period number, ultimately resulting in a wrong decrypted second authentication code.

For example, assuming that cyclic time period numbers are 0, 1, 2, 3, . . . , and 39 and the dynamic time interval T=90 seconds, in this case, the server device obtains the current time, with the minute of 2 and the second of 58, and obtains J=01 through computation of formula (1). Due to the variability of the time, the server device needs to process the obtained first authentication code to obtain the image authentication code and then sends the image authentication code to the client device. If the minute and the second of the time in the image authentication code sent by the server device are 3 and 0, the client device needs to generate the second authentication code based on its own device time, and obtains a time period number of 02 through computation of formula (1). However, a time period number in the first authentication code obtained by decrypting the image authentication code sent by the server device is 01, leading to an identity authentication error, and thereby causing the client device to mistakenly consider the server device to have a forgery identity. Such case is not allowed, and the above steps S51-S52 need to be executed in this case.

In step S51, when it is determined for the first time that the second authentication code is inconsistent with the first authentication code, the time period number is updated to the time period number of the previous time period, and it is returned to the step of performing the computation on the current time of the client device, the time period number, and the dynamic time interval to obtain the initial second authentication code, thereby obtaining the updated second authentication code. In an implementation, when a first time of authentication fails, in a second time of authentication, the client device cyclically shifts forward the current time period number by one time period number. For example, if the current time period number is 02, when the authentication comparison fails, the current time period number is shifted forward by one time period number to obtain a time period number of 01, and then the authentication comparison, i.e., step S52, is performed. If the comparison succeeds, a correct identity authentication process continues. If the authentication comparison fails, it is determined that the server device is determined as a forgery server device, and the information is not received from this server device subsequently.

In a particular implementation, the devices in the Internet of Things may also be updated. The administrator can perform the following updates:
(1) updating the range of the agreed time interval T in the server device;
(2) updating the range of the agreed encryption number in the server device;
(3) updating the permissions of the user in the server device, such as canceling a permission to add a client device, adding permissions to delete a client device, and modifying the password information of client devices, etc.;
(4) changing a random password generated during the client device registration; and
(5) adding or deleting a user and a client device.

The server device performs the following updates:
(1) randomly selecting one numerical value from the set range of the agreed time interval T every day as an agreed time interval for that day, and sending this rule to the client device;
(2) randomly selecting one numerical value from the set range of the agreed encryption number every day as an agreed encryption number for that day, and sending this rule to the client device;
(3) updating the password information of the client device changed by the user, and sending the password information to the client device for update; and
(4) randomly selecting P*8 points from a set range of numbers of rows and columns in the modified authentication code pictures every day as authentication code picture modification points for that day, and sending this rule to the client device.

The client device performs the following updates:
(1) simultaneously accepting rules that are updated by the server device every date; and
(2) receiving the password information of the client device changed by the user in the server device, and storing the information.

The user performs the following updates:
(1) the user may change the password entered during the registration in the server device; and
(2) the user may change the password information of the client device in the server device, but cannot modify the account information of the client device. Changed information will be sent by the server device to the client device.

In the existing technology, there are mainly 4 commonly used identity authentication patterns in the Internet-of-Things system, i.e., smart card authentication, user name/password authentication, dynamic password authentication, and digital certificate-based identity authentication respectively, which are detailed as follows:

(1) Smart card authentication: the smart card-based identity authentication belongs to a mechanism of performing identity authentication through a physical device. Each user holds a smart card that stores secret information of the user, and the secret information is also stored in an authentication server. During the authentication, the user enters a Personal Identification Number (PIN), the server authenticates the PIN, and the secret information in the smart card may be read out once the authentication succeeds, so as to perform authentication with a host using the secret information. A smart card-based authentication pattern is a two-factor authentication pattern (PIN+smart card), and even if the PIN or smart card is stolen separately, an identity of a legitimate user still cannot be forged (i.e., an access right cannot be obtained).

(2) User name/password authentication: the user name/password is a simplest and commonest identity authentication method and is an authentication means that is based on “what you know”. A password of each user is set by the user and known only by the user. As long as the user enters the correct password, a computer considers the operator to be a legitimate user.

(3) Dynamic password authentication: a basic authentication principle of a dynamic password is that both parties of authentication use the same shared key to perform a password algorithm computation on the time, and then compare computed values to determine whether they are consistent, thereby implementing the authentication, e.g., a TOTP algorithm (Time-based One-time Password algorithm). TOTP is an example of a Hash-based Message Authentication Code (HMAC), which uses a cryptographic hash function to combine a key and a current time stamp together to generate a one-time password. Since a network latency and unsynchronized clocks may cause a password recipient to have to attempt identity authentication using a series of possible times, the time stamps are typically increased at an interval of 30 seconds.

(4) Digital certificate-based identity authentication: the digital certificate-based identity authentication is a digital certificate-based authentication pattern that is based on a PKI (Public Key Infrastructure) architecture. A digital certificate is a set of data structures containing user identity information (a key) issued by a trustable third-party authentication agency. A PKI system constructs a well-established process using an encryption algorithm, and a protection password of a certificate file needs to be entered during the identity authentication.

The above existing technologies (1)-(4) have the following problems:

(1) Smart card authentication: since data read from the smart card every time is static, it is very easy to intercept identity authentication information of the user through technologies such as memory scanning or network sniff. Moreover, a smart card needs to be added to a device. The smart card is easy to guess and attack, for example, by snooping, a dictionary attack, an exhaustive attempt, network data stream eavesdropping, a replay attack, etc.

(2) User name/password authentication: the password is static data and therefore needs to be transmitted in a computer memory and a network during an authentication process, with the same authentication information used for each time of authentication, making the password be easy to guess and attack, by snooping, a dictionary attack, an exhaustive attempt, network data stream eavesdropping, a replay attack, etc. Therefore, from the perspective of security, the user name/password authentication and the smart card authentication are both extremely insecure authentication patterns.

(3) Dynamic password authentication: a password generation algorithm in a client and a server uses a pseudo random sequence generator technology, and continuous leakage occurs once the algorithm is cracked. If the client and the server cannot maintain good time or frequency synchronization, a problem of the legitimate user being unable to log in may occur. For example, in a time duration of the same hash validity period, results of dynamic password generation are the same. However, due to a network, the time when the client generates a password and the time when the server accepts a password may differ greatly, so that two passwords are not in the time duration of the same hash validity period, leading to authentication failure. In this case, an authentication system needs to have a delay strategy that allows authentication of dynamic passwords in time durations of several hash validity periods earlier. If authentication in the several time periods earlier are allowed, the Internet-of-Things device may perform cyclic decryption multiple times, and the TOTP protocol involves multiple recursive iterations and public and private keys, resulting in excessive resource consumption. In a scenario of the Internet of Things, computing resources and energy supplies are very limited, and sufficient resources and energy support cannot be provided.

(4) Digital certificate-based authentication: a jointly trusted third-party organization, i.e., Certificate Authority (CA), is required to be added to issue a digital certificate, and the digital certificate has a certain time limit. The addition of the third-party organization to the identity authentication system of the Internet of Things makes the identity authentication process excessively cumbersome.

As can be seen from the above analyses, static information is transmitted in first and second types of identity authentication processes. In addition, the first type of identity authentication requires the addition of a smart card during the authentication process, and the static information is easy to intercept during the device identity authentication process. The third type of identity authentication method generates a long and irregular password string that needs to be entered by the user. Once an entering error occurs, the entering needs to be restarted, which may require multiple times of decryption, involving multiple recursive iterations and public and private keys, and resulting in excessive resource consumption. The fourth type of method requires the introduction of the third-party organization, which issues the digital certificate with a specified time limit to the devices, making the use of the Internet-of-Things devices relatively troublesome.

In the embodiments of the present disclosure, the client device performs identity authentication for the server device, and then sends the processed third authentication code and the encrypted data packet to the server device after determining that the identity of the server device is valid. The server device then performs identity authentication for the client device, thereby achieving bidirectional authentication between both interaction parties. Meanwhile, the embodiments of the present disclosure do not require multiple times of cyclic decryptions and do not involve multiple recursive iterations or public or private keys, etc., have the advantages of few resources occupied and a fast authentication speed, and are applicable to devices with low computer technology capabilities and storage resources.

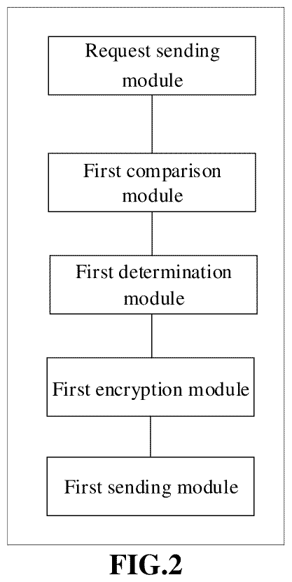

Referring to FIG. 2, second embodiments of the present disclosure provide an Internet-of-Things device identity authentication apparatus, which is disposed in a client device and comprises:
a request sending module configured to send identity authentication request information to a server device, so that the server device receives the identity authentication request information, generates a first authentication code according to a preset first encryption algorithm, and sends the first authentication code to the client device;
a first comparison module configured to receive the first authentication code, generate a second authentication code according to the first encryption algorithm, and compare the second authentication code with the first authentication code;
a first determination module configured to determine that an identity of the server device is valid when determining that the second authentication code is consistent with the first authentication code;
a first encryption module configured to encrypt the first authentication code according to a preset second encryption algorithm to generate a third authentication code after determining that the identity of the server device is valid; and
a first sending module configured to send the third authentication code and a preconfigured encrypted data packet to the server device, so that the server device runs the second encryption algorithm reversely to decrypt the received third authentication code to generate a fourth authentication code, compares the fourth authentication code with the first authentication code, decrypts the received encrypted data packet to obtain device authentication information when determining that the fourth authentication code is consistent with the first authentication code, and determines that an identity of the client device is valid when determining that the device authentication information is consistent with device-specific information of the client device.

In an implementation, the apparatus further comprises:
an image receiving module configured to receive an image authentication code, and run a preset image generation algorithm reversely to decrypt the image authentication code to obtain the first authentication code, wherein the image authentication code is generated by the server device according to the image generation algorithm and the first authentication code and sent to the client device.

In an implementation, the image receiving module is further configured to:
read information of the image authentication code, and delete preset interference information, so as to obtain a decimal numerical value;
convert the decimal numerical value into a binary numerical value, and perform a reverse bitwise cyclic operation on the binary numerical value, so as to obtain an initial binary numerical value; and
perform a decimal conversion on the initial binary numerical value to obtain the first authentication code.

In an implementation, the apparatus further comprises:
an update comparison module configured to update the time period number to a time period number of a previous time when it is determined for a first time that the second authentication code is inconsistent with the first authentication code, and return to the step of performing the computation on the current time of the client device, the time period number, and the dynamic time interval to obtain the initial second authentication code, thereby obtaining an updated second authentication code; and
compare the updated second authentication code with the first authentication code.

In an implementation, the first encryption module comprises:
a first encryption module configured to add a preset encryption number to the first authentication code to generate the third authentication code.

In another embodiment, the foregoing Internet-of-Things device identity authentication apparatus includes a processor, where the processor is configured to execute the foregoing program modules stored in a memory, including a request sending module, a first comparison module, a first determination module, a first encryption module, and a first sending module.

In the embodiments of the present disclosure, the client device performs identity authentication for the server device, and then sends the processed third authentication code and the encrypted data packet to the server device after determining that the identity of the server device is valid. The server device then performs identity authentication for the client device, thereby achieving bidirectional authentication between both interaction parties. Meanwhile, the embodiments of the present disclosure do not require multiple times of cyclic decryptions and do not involve multiple recursive iterations or public or private keys, etc., have the advantages of few resources occupied and a fast authentication speed, and are applicable to devices with low computer technology capabilities and storage resources.

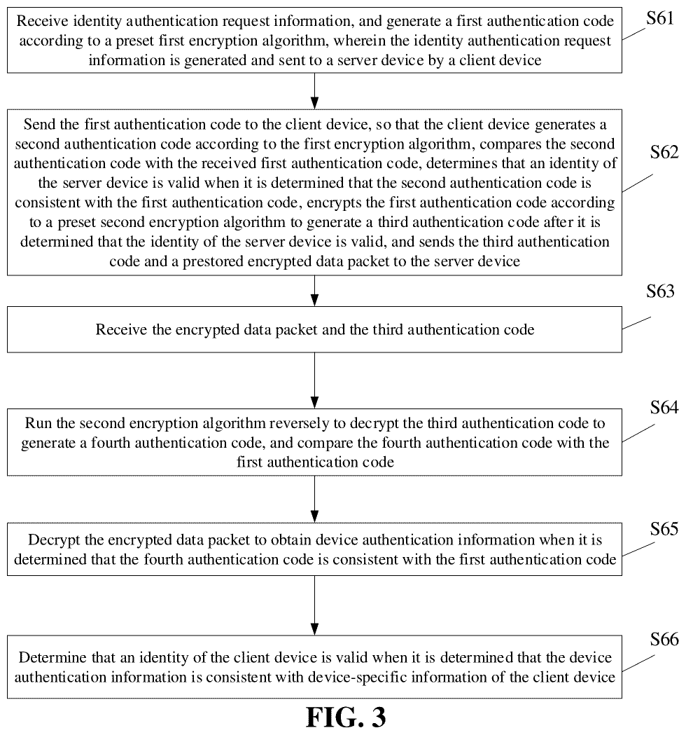

Referring to FIG. 3, third embodiments of the present disclosure provide an Internet-of-Things device identity authentication method, which comprises the following steps S61-S66:
S61, receiving identity authentication request information, and generating a first authentication code according to a preset first encryption algorithm, wherein the identity authentication request information is generated and sent to a server device by a client device;
S62, sending the first authentication code to the client device, so that the client device generates a second authentication code according to the first encryption algorithm, compares the second authentication code with the received first authentication code, determines that an identity of the server device is valid when determining that the second authentication code is consistent with the first authentication code, encrypts the first authentication code according to a preset second encryption algorithm to generate a third authentication code after determining that the identity of the server device is valid, and sends the third authentication code and a preconfigured encrypted data packet to the server device;
S63, receiving the encrypted data packet and the third authentication code;
S64, running the second encryption algorithm reversely to decrypt the third authentication code to generate a fourth authentication code, and comparing the fourth authentication code with the first authentication code;
S65, decrypting the encrypted data packet to obtain device authentication information when determining that the fourth authentication code is consistent with the first authentication code; and
S66, determining that an identity of the client device is valid when determining that the device authentication information is consistent with device-specific information of the client device.

It is to be noted that registration of the client device in Internet-of-Things devices is required to be performed before the authentication starts. After a user registration succeeds, a user logs in the server device and initiates a client device registration application after the login succeeds. The server device returns a device-specific information submission interface according to received client device registration application information. The user enters the device-specific information of the client device on the interface, e.g., a unique IP address and a machine code, etc. of the device, and sends the device-specific information to the server device.

Further, the server device receives the device-specific information sent by the client device, generates a specific data packet, and encrypts the specific data packet using a preset specific encryption algorithm to generate the encrypted data packet. The server device sends the encrypted data packet to the client device. The client device receives the encrypted data packet and preconfigures and stores the encrypted data packet to a designated location. The specific encryption algorithm is agreed and configured by both parties in advance, for example, a Data Encryption Algorithm (DEA) may be used, which is not limited in the present disclosure. Further, the server device may also generate a device-dedicated program based on the device-specific information and send the program to the client device.

In step S61, the client device sends the identity authentication request information to the server device. The server device receives the identity authentication request information, and generates the first authentication code according to the preset first encryption algorithm. Specific processes have been described in steps S21-S23 and are no longer repeated herein.

In step S62, the first authentication code is sent to the client device. The client device generates the second authentication code according to the first encryption algorithm, compares the second authentication code with the received first authentication code, determines that the identity of the server device is valid when determining that the second authentication code is consistent with the first authentication code, encrypts the first authentication code according to the preset second encryption algorithm to generate the third authentication code after determining that the identity of the server device is valid, and sends the third authentication code and the preconfigured encrypted data packet to the server device.

In step S63, the server device receives the encrypted data packet and the third authentication code.

In step S64, the second encryption algorithm is run reversely to decrypt the third authentication code to generate the fourth authentication code, and the fourth authentication code is compared with the first authentication code. In an implementation, the server device receives the string sent by the client device, and deletes the encryption number from the third authentication code to generate the fourth authentication code.

In step S65, the server device compares the decrypted fourth authentication code with the first authentication code. When the fourth authentication code is determined to be consistent with the first authentication code, it indicates that the comparison succeeds.

In step S66, the server device then decrypts the encrypted data packet at the rear of the string, so as to read the device authentication information that comprises an account and a password of the device. It is to be noted that, in the case where it is determined that the fourth authentication code is inconsistent with the first authentication code, the server device does decrypt the encrypted data packet and does not obtain the account and password information.

Further, when determining that the device authentication information is consistent with the device-specific information, the identity of the client device is determined to be valid, and authentication passing information is sent to the client device. When the device authentication information is determined to be inconsistent with the device-specific information, it indicates that account and password authentication fails, and password error information is sent to the client device.

In the embodiments of the present disclosure, the client device performs identity authentication for the server device, and then sends the processed third authentication code and the encrypted data packet to the server device after determining that the identity of the server device is valid. The server device then performs identity authentication for the client device, thereby achieving bidirectional authentication between both interaction parties. Meanwhile, the embodiments of the present disclosure do not require multiple times of cyclic decryptions and do not involve multiple recursive iterations or public or private keys, etc., have the advantages of few resources occupied and a fast authentication speed, and are applicable to devices with low computer technology capabilities and storage resources.

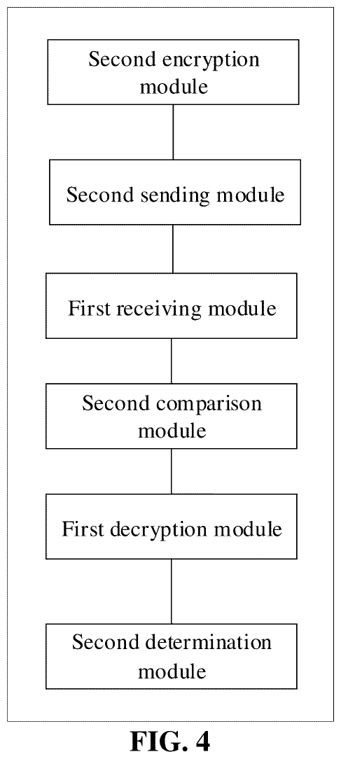

Referring to FIG. 4, fourth embodiments of the present disclosure provide an Internet-of-Things device identity authentication apparatus, which is disposed in a server device and comprises:
a second encryption module configured to receive identity authentication request information, and generate a first authentication code according to a preset first encryption algorithm, wherein the identity authentication request information is generated and sent to the server device by a client device;
a second sending module configured to send the first authentication code to the client device, so that the client device generates a second authentication code according to the first encryption algorithm, compares the second authentication code with the received first authentication code, determines that an identity of the server device is valid when determining that the second authentication code is consistent with the first authentication code, encrypts the first authentication code according to a preset second encryption algorithm to generate a third authentication code after determining that the identity of the server device is valid, and sends the third authentication code and a preconfigured encrypted data packet to the server device;
a first receiving module configured to receive the encrypted data packet and the third authentication code;
a second comparison module configured to run the second encryption algorithm reversely to decrypt the third authentication code to generate a fourth authentication code, and compare the fourth authentication code with the first authentication code;
a first decryption module configured to decrypt the encrypted data packet to obtain device authentication information when determining that the fourth authentication code is consistent with the first authentication code; and
a second determination module configured to determine that an identity of the client device is valid when determining that the device authentication information is consistent with device-specific information of the client device.

In an implementation, the second encryption module comprises:
a time obtaining unit configured to generate a time period number according to a preset dynamic time interval and obtained current time of the server device;
an initial first authentication code generation unit configured to perform computation on the current time of the server device, the time period number, and the dynamic time interval, so as to obtain an initial first authentication code; and
a first authentication code generation unit configured to process the initial first authentication code according to a preset number of authentication code bits, so as to obtain the first authentication code.

In an implementation, the apparatus further comprises:

an image authentication code generation module configured to generate an image authentication code according to a preset image generation algorithm and the first authentication code, and send the image authentication code to the client device, so that the client device runs the image generation algorithm reversely to decrypt the received image authentication code to obtain the first authentication code.

In an implementation, the image authentication code generation module comprises:
a system conversion unit configured to convert the first authentication code into an initial binary numerical value;
a cyclic operation unit configured to perform a bitwise cyclic operation on the initial binary numerical value to obtain a binary numerical value;
an initial image authentication code generation unit configured to write the binary numerical value to image data preconfigured by the server device, so as to generate an initial image authentication code; and
an image authentication code generation unit configured to add preset interference information to the initial image authentication code to generate the image authentication code.

In an implementation, the second comparison module comprises:
a fourth authentication code generation unit configured to delete a preset encryption number from the third authentication code to generate the fourth authentication code.

In another embodiment, the foregoing Internet-of-Things device identity authentication apparatus includes a processor, where the processor is configured to execute the foregoing program modules stored in a memory, including a second encryption module, a second sending module, a first receiving module, a second comparison module, a first decryption module, and a second determination module.

In the embodiments of the present disclosure, the client device performs identity authentication for the server device, and then sends the processed third authentication code and the encrypted data packet to the server device after determining that the identity of the server device is valid. The server device then performs identity authentication for the client device, thereby achieving bidirectional authentication between both interaction parties. Meanwhile, the embodiments of the present disclosure do not require multiple times of cyclic decryptions and do not involve multiple recursive iterations or public or private keys, etc., have the advantages of few resources occupied and a fast authentication speed, and are applicable to devices with low computer technology capabilities and storage resources.

Fifth embodiments of the present disclosure provide an Internet-of-Things device identity authentication system comprising a client device and a server device that are communicatively connected with each other. The client device is configured to execute the Internet-of-Things device identity authentication method as described in any one the first embodiments. The server device is configured to execute the Internet-of-Things device identity authentication method as described in any one of the third embodiments.

It is to be noted that during an identity authentication process, an image authentication code is generally generated and sent to the client device by the server device for identity authentication processing. In another embodiment, identities of the server device and the client device may be interchanged, that is, the image authentication code is generated and sent to the server device by the client device for the identity authentication processing.

Sixth embodiments of the present disclosure provide a computer-readable storage medium comprising a stored computer program, wherein the computer program, when being run, controls a device where the computer-readable storage medium is located to execute the Internet-of-Things device identity authentication method as described in any one of the first embodiments or the Internet-of-Things device identity authentication method as described in any one the third embodiments.

To sum up, the present disclosure provides an Internet-of-Things device identity authentication method, apparatus, and system, and a computer-readable storage medium. A client device performs identity authentication for a server device, and then sends a processed third authentication code and an encrypted data packet to the server device after determining that an identity of the server device is valid. The server device then performs identity authentication for the client device, thereby achieving bidirectional authentication between both interaction parties. Meanwhile, the embodiments of the present disclosure do not require multiple times of cyclic decryptions and do not involve multiple recursive iterations or public or private keys, etc., have the advantages of few resources occupied and a fast authentication speed, and are applicable to devices with low computer technology capabilities and storage resources.

For example, the computer program may be divided into one or more modules/unit that are stored in a memory and executed by a processor to implement the present disclosure. The one or more modules/unit may be a series of computer program instruction segments capable of implementing particular functions, and the instruction segments are used to describe an execution process of the computer program in the client device or the server device.

The processor may comprise a central processing unit (CPU), or may comprise other general-purpose processors, a digital signal processor (DSP), an application specific integrated circuit (ASIC), a field-programmable gate array (FPGA), or other programmable logic devices, discrete gates or transistor logic devices, discrete hardware components, etc. The general-purpose processors may comprise a microprocessor or any conventional processor, etc. The processor is a control center of the client device or the server device, and connects various parts of the entire client device or the server device through various interfaces and lines.

The memory may be configured to store the computer program and/or modules. The processor achieves various functions of the client device or the server device by running or executing the computer program and/or modules stored in the memory, as well as calling data stored in the memory. The memory may mainly comprise a program storage region and a data storage region, wherein the program storage region may store an operating system, an application program required by at least one function (such as a sound playing function, an image displaying function, etc.), etc. The data storage region may store data (such as audio data, a phone book, etc.) created according to the use of a mobile phone, etc. In addition, the memory may comprise a high-speed random-access memory, and may also comprise a non-volatile memory, such as a hard disk, a memory, a plug-in hard disk, a Smart Media Card (SMC), a Secure Digital (SD) card, a Flash Card, at least one disk storage device, a flash memory device, or other volatile solid-state storage devices.

If the modules/unit integrated in the client device or the server device are implemented in a form of software functional unit and sold or used as independent products, these modules/unit may be stored in a computer-readable storage medium. Based on such understanding, the present disclosure implements all or part of the processes in the method of the above embodiments, which may be also implemented by instructing relevant hardware through a computer program. The computer program may be stored in a computer-readable storage medium, and when executed by the processor, may implement the steps of each of the above method embodiments. The computer program comprises a computer program code which may be in a form of a source code, an object code or an executable file, or some intermediate forms. The computer-readable medium may comprise: any entity or apparatus capable of carrying the computer program code, a recording medium, a USB flash disk, a mobile hard disk, a diskette, an optical disk, a computer memory, a Read-Only Memory (ROM), a Random Access Memory (RAM), an electric carrier signal, a telecommunication signal, a software distribution medium, etc. It is to be noted that the contents contained in the computer-readable medium may be appropriately increased or decreased according to the requirements of legislation and patent practice in jurisdictions. For example, in some jurisdictions, according to the legislation and patent practice, the computer-readable medium comprises no electric carrier signal or telecommunication signal.

It is to be noted that the apparatus embodiments described above are only schematic, where unit described as separate components may be or may not be physically separated from each other, and components displayed as unit may be or may not be physical unit, and may be located in the same place or distributed on multiple network unit. Part or all of the modules may be selected according to an actual need to achieve the purposes of the solutions of the embodiments. In addition, in the drawings of the apparatus embodiments provided by the present disclosure, a connection relationship between the modules indicates the presence of a communicative connection therebetween, which may be implemented as one or more communication buses or signal lines. Those of ordinary skill in the art can understand and implement the present disclosure without the practice of inventive effort.

The particular embodiments described above provide a further detailed explanation of the purpose, technical solution, and beneficial effect of the present disclosure. It should be understood that the above are only particular embodiments of the present disclosure and are not intended to limit the scope of protection of the present disclosure. It is to be pointed out particularly that, for those skilled in the art, any modifications, equivalent replacements, improvements, etc. made within the spirit and principles of the present disclosure should be encompassed in the scope of protection of the present disclosure.

What is claimed is:

1. An Internet-of-Things device identity authentication method, performed by a client device and comprising:
sending identity authentication request information to a server device, so that the server device receives the identity authentication request information, generates a first authentication code according to a preset first encryption algorithm, and sends the first authentication code to the client device, or generates an image authentication code according to a preset image generation algorithm and the first authentication code and sends the image authentication code to the client device;
receiving the first authentication code, or receiving the image authentication code and running the image generation algorithm reversely to decrypt the image authentication code to obtain the first authentication code, generating a second authentication code according to the first encryption algorithm, and comparing the second authentication code with the first authentication code;
determining that an identity of the server device is valid when it is determined that the second authentication code is consistent with the first authentication code;
encrypting the first authentication code according to a preset second encryption algorithm to generate a third authentication code after it is determined that the identity of the server device is valid; and
sending the third authentication code and a preconfigured encrypted data packet to the server device, so that the server device runs the second encryption algorithm reversely to decrypt the received third authentication code to generate a fourth authentication code, compares the fourth authentication code with the first authentication code, decrypts the received encrypted data packet to obtain device authentication information when it is determined that the fourth authentication code is consistent with the first authentication code, and determines that an identity of the client device is valid when it is determined that the device authentication information is consistent with device-specific information of the client device.

2. The Internet-of-Things device identity authentication method according to claim 1, wherein the running the preset image generation algorithm reversely to decrypt the image authentication code to obtain the first authentication code comprises:
reading information of the image authentication code, and deleting preset interference information, so as to obtain a decimal numerical value;
converting the decimal numerical value into a binary numerical value, and performing a reverse bitwise cyclic operation on the binary numerical value, so as to obtain an initial binary numerical value; and
performing a decimal conversion on the initial binary numerical value to obtain the first authentication code.

3. The Internet-of-Things device identity authentication method according to claim 1, wherein the generating the second authentication code according to the first encryption algorithm comprises:
generating a time period number according to a preset dynamic time interval and obtained current time of the client device;
performing computation on the current time of the client device, the time period number, and the dynamic time interval to obtain an initial second authentication code; and
processing the initial second authentication code according to a preset number of authentication code bits, so as to obtain the second authentication code.

4. The Internet-of-Things device identity authentication method according to claim 3, further comprising:
updating the time period number to a time period number of a previous time when it is determined for a first time that the second authentication code is inconsistent with the first authentication code, and returning to the step of performing the computation on the current time of the client device, the time period number, and the dynamic time interval to obtain the initial second authentication code, thereby obtaining an updated second authentication code; and
comparing the updated second authentication code with the first authentication code.

5. The Internet-of-Things device identity authentication method according to claim 1, wherein the encrypting the first authentication code according to the preset second encryption algorithm to generate the third authentication code comprises:
adding a preset encryption number to the first authentication code to generate the third authentication code.

6. An Internet-of-Things device identity authentication apparatus, wherein the apparatus is disposed in a client device and is configured to perform the Internet-of-Things device identity authentication method according to claim 1, and comprises:
a request sending module configured to send identity authentication request information to a server device, so that the server device receives the identity authentication request information, generates a first authentication code according to a preset first encryption algorithm, and sends the first authentication code to the client device;
a first comparison module configured to receive the first authentication code, generate a second authentication code according to the first encryption algorithm, and compare the second authentication code with the first authentication code;
a first determination module configured to determine that an identity of the server device is valid when it is determined that the second authentication code is consistent with the first authentication code;
a first encryption module configured to encrypt the first authentication code according to a preset second encryption algorithm to generate a third authentication code after it is determined that the identity of the server device is valid; and
a first sending module configured to send the third authentication code and a preconfigured encrypted data packet to the server device, so that the server device runs the second encryption algorithm reversely to decrypt the received third authentication code to generate a fourth authentication code, compares the fourth authentication code with the first authentication code, decrypts the received encrypted data packet to obtain device authentication information when determining that the fourth authentication code is consistent with the first authentication code, and determines that an identity of the client device is valid when it is determined that the device authentication information is consistent with device-specific information of the client device.

7. An Internet-of-Things device identity authentication method, performed by a server device and comprising:
receiving identity authentication request information, and generating a first authentication code according to a preset first encryption algorithm, wherein the identity authentication request information is generated and sent to the server device by a client device;
sending the first authentication code to the client device, or generating an image authentication code according to a preset image generation algorithm and the first authentication code and sending the image authentication code to the client device, so that the client device generates a second authentication code according to the first encryption algorithm, compares the second authentication code with the received first authentication code or runs the image generation algorithm reversely to decrypt the received image authentication code to obtain the first authentication code, compares the second authentication code with the received first authentication code, determines that an identity of the server device is valid when it is determined that the second authentication code is consistent with the first authentication code, encrypts the first authentication code according to a preset second encryption algorithm to generate a third authentication code after it is determined that the identity of the server device is valid, and sends the third authentication code and a preconfigured encrypted data packet to the server device;
receiving the encrypted data packet and the third authentication code;
running the second encryption algorithm reversely to decrypt the third authentication code to generate a fourth authentication code, and comparing the fourth authentication code with the first authentication code;
decrypting the encrypted data packet to obtain device authentication information when it is determined that the fourth authentication code is consistent with the first authentication code; and
determining that an identity of the client device is valid when it is determined that the device authentication information is consistent with device-specific information of the client device.

8. The Internet-of-Things device identity authentication method according to claim 7, wherein the generating the first authentication code according to the first encryption algorithm comprises:
generating a time period number according to a preset dynamic time interval and the obtained current time of the server device;
performing computation on the current time of the server device, the time period number, and the dynamic time interval, so as to obtain an initial first authentication code; and
processing the initial first authentication code according to a preset number of authentication code bits, so as to obtain the first authentication code.

9. The Internet-of-Things device identity authentication method according to claim 7, wherein the generating the image authentication code according to the preset image generation algorithm and the first authentication code comprises:
converting the first authentication code into an initial binary numerical value;
performing a bitwise cyclic operation on the initial binary numerical value to obtain a binary numerical value;
writing the binary numerical value to image data preconfigured by the server device, so as to generate an initial image authentication code; and
adding preset interference information to the initial image authentication code to generate the image authentication code.

10. The Internet-of-Things device identity authentication method according to claim 7, wherein the running the second encryption algorithm reversely to decrypt the third authentication code to generate the fourth authentication code comprises:
deleting a preset encryption number from the third authentication code to generate the fourth authentication code.

11. An Internet-of-Things device identity authentication apparatus, wherein the apparatus is disposed in a server device and is configured to perform the Internet-of-Things device identity authentication method according to claim 7, and comprises:
a second encryption module configured to receive identity authentication request information, and generate a first authentication code according to a preset first encryption algorithm, wherein the identity authentication request information is generated and sent to the server device by a client device;
a second sending module configured to send the first authentication code to the client device, so that the client device generates a second authentication code according to the first encryption algorithm, compares the second authentication code with the received first authentication code, determines that an identity of the server device is valid when it is determined that the second authentication code is consistent with the first authentication code, encrypts the first authentication code according to a preset second encryption algorithm to generate a third authentication code after it is determined that the identity of the server device is valid, and sends the third authentication code and a preconfigured encrypted data packet to the server device;
a first receiving module configured to receive the encrypted data packet and the third authentication code;
a second comparison module configured to run the second encryption algorithm reversely to decrypt the third authentication code to generate a fourth authentication code, and compare the fourth authentication code with the first authentication code;
a first decryption module configured to decrypt the encrypted data packet to obtain device authentication information when it is determined that the fourth authentication code is consistent with the first authentication code; and
a second determination module configured to determine that an identity of the client device is valid when it is determined that the device authentication information is consistent with device-specific information of the client device.

12. An Internet-of-Things device identity authentication system, comprising: a client device and a server device that are communicatively connected with each other, wherein the client device is configured to perform the Internet-of-Things device identity authentication method according to claim 1.

13. An Internet-of-Things device identity authentication system, comprising: a client device and a server device that are communicatively connected with each other, wherein the server device is configured to perform the Internet-of-Things device identity authentication method according to claim 7.

14. A computer-readable storage medium, comprising: a stored computer program, wherein when the computer program is run, a device where the computer-readable storage medium is located is controlled to perform the Internet-of-Things device identity authentication method according to claim 1.

15. A computer-readable storage medium, comprising: a stored computer program, wherein when the computer program is run, a device where the computer-readable storage medium is located is controlled to perform the Internet-of-Things device identity authentication method according to claim 7.
